(19) United States
(12) Patent Application Publication
(10) Pub. No.: US 2006/0185204 A1
(43) Pub. Date: Aug. 24, 2006

(54) Internally illuminated sign

(76) Inventors: Andrew S. Holt, Bountiful, UT (US); Brian Garner, Salt Lake City, UT (US)

Correspondence Address: BRINKS HOFER GILSON & LIONE, P.O. BOX 10395, CHICAGO, IL, 60610, US

(21) Appl. No.: 11/346,477

(22) Filed: Feb. 2, 2006

Related U.S. Application Data
(60) Provisional application No. 60/650,604, filed on Feb. 7, 2005.

(51) Int. Cl. G09F 13/04

(52) U.S. Cl. 40/564

(57) ABSTRACT

An internally illuminated sign includes an elongated housing defining an interior chamber. The housing has opposite end portions, at least one side portion and an elongated member disposed between the opposite end portions. The side portion includes instructional indicia and permits the transmission of light therethrough. A plurality of induction lamps are disposed in the interior chamber and are connected to the elongated member. The induction lamps are spaced apart along a longitudinal direction.

This application claims the benefit of U.S. Provisional Patent Application No. 60/650,604, filed Feb. 7, 2005, the entire disclosure of which is hereby incorporated herein by reference.

### FIELD OF THE INVENTION

This invention relates to a sign, and in particular to an internally illuminated sign.

### BACKGROUND

Signs, such as street signs, are often internally illuminated to provide passersby with instructional information, such as street names and/or directional information. Often, such signs are elongated, for example in a horizontal direction, to accommodate the instructional information. Typically, such signs include a housing illuminated with elongated fluorescent lights, which can provide a relatively uniform illumination or even distribution light and reduce the possibility of hot spots visible to the user or passerby. Such lights, however, may have relatively lengthy ignition times and limited life spans, thereby requiring relatively frequent evaluation and maintenance.

### SUMMARY

In one aspect, an internally illuminated sign includes an elongated housing defining an interior chamber and a longitudinal axis. The housing has opposite end portions, at least one side portion and an elongated member connected to and extending between the opposite end portions. The side portion includes instructional indicia and permits the transmission of light therethrough. A plurality of induction lamps are disposed in the interior chamber and are connected to the elongated member. The plurality of induction lamps are spaced apart along a longitudinal direction.

In one embodiment, a first reflector is disposed adjacent the plurality of induction lamps. In one embodiment, a second reflector is spaced from the first reflector. In various embodiments, the first and second reflectors each include one or more reflective surfaces. In one embodiment, the elongated member forms at least part of a base portion, and the housing further includes a cap portion spaced from the base portion. The first reflector is positioned adjacent the base portion, while the second reflector is positioned adjacent the cap portion.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a perspective view of a first embodiment of an internally illuminated sign without side portions.

FIG. 2 is a partially exploded, perspective view of a base portion, a plurality of induction lamps and a pair of first reflectors.

FIG. 3 is a cross-sectional view of the sign shown in FIG. 1 taken along line 3-3 with the side portions installed thereon.

FIG. 4 is a side view of an alternative embodiment of an induction lamp.

FIGS. 5A-C are exemplary embodiments of a side portion having instructional indicia.

FIG. 6 is a side view of one embodiment of a sign with mounting hardware, but without any instructional indicia.

FIG. 7 is an enlarged portion of the cross-sectional view of the sign shown in FIG. 3 taken along line 7.

FIG. 8 is an enlarged portion of the cross-sectional view of the sign shown in FIG. 3 taken along line 8.

### DETAILED DESCRIPTION OF THE PRESENTLY PREFERRED EMBODIMENTS

Referring to FIGS. 1 and 6, an internally illuminated sign 6 is shown as including a housing 28 having opposite end portions 4, a base portion 8, a cap portion 10 and opposite side portions 12, all of which are configured as wall members in one embodiment. It should be understood that the base portion can be located at the top of the sign and the cap portion at the bottom thereof in one embodiment, or vice versa the base portion can be located at the bottom with the cap portion at the top. In one embodiment, the sign 6 is elongated, with the base, cap and side portions extending in a longitudinal direction 2. The term “longitudinal” refers to the lengthwise direction between the opposite end portions 4.

In one embodiment, the end portions 4 have tapered side edges, such that the base portion 8 has a greater width than the cap portion 10. It should be understood that the end portions could be rectangular, polygonal, circular, oval, or any other suitable shape. Likewise, the housing 28 can have an overall cylindrical shape, a parallelepiped shape (rectangular or other), a cubic shape, a spherical shape, or any other suitable shape. In an embodiment of the housing having a cylindrical shape, for example, it should be understood that various portions of the cylinder could form the base, cap and side portions, for example, ¼ portions thereof. In such an embodiment, the side portion is considered any portion of the cylinder having instructional indicia. Indeed, in any embodiment, the phrase “side portion” refers to the portion of the housing having instructional indicia and through which light is transmitted from the interior of the housing.

It should be understood that the end portions, side portions, cap portion and base portion can be made as separate elements, or that two or more components thereof can be integrally formed as a single element. In various embodiments, the end portions, cap portion and base portion are made of a relatively rigid material, such as metal, including for example and without limitation aluminum or steel, plastic, fiberglass, composites or other like materials.

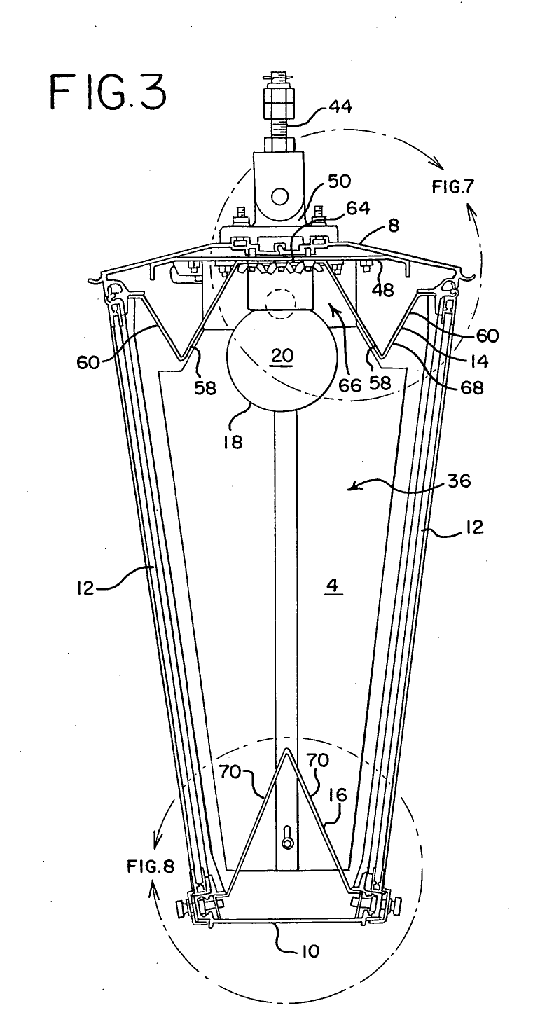

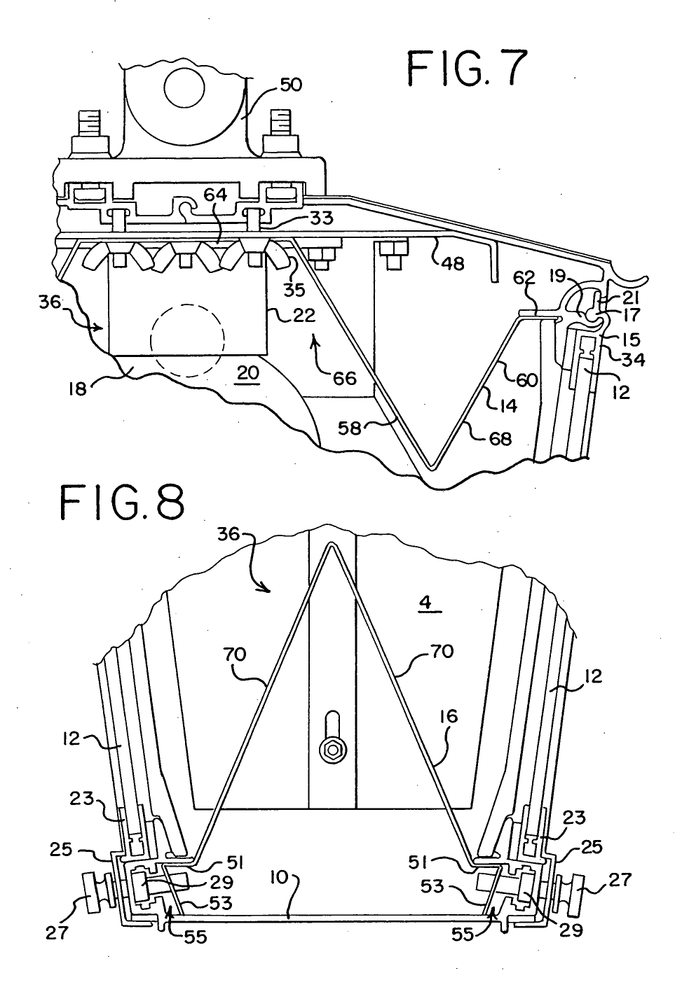

Referring to FIG. 1, the base and cap portions 8, 10 have opposite ends 32, 30 thereof connected to the opposite end portions 4 respectively. For example, in one embodiment, the base and cap portions are formed as extrusions, with the end portions being attached thereto by welding, although they can also be attached with various fasteners (integral and/or mechanical), adhesives, etc. The terms “secured,” “connected” and variations thereof as used herein means coupled, connected or secured, whether directly or indirectly, for example by way of an intervening member. The side portions 12, formed as panels in one embodiment, are removably secured to the cap and base portions 8, 10. For example, as shown in FIGS. 3, 7 and 8, one or both of the longitudinal edges 34 of the side portion 12 can include an extruded rail portion 15 defining a hinge portion, for example a bead 17 or groove, that is hingedly engaged with a corresponding hinge portion, shown as a groove 19, extruded along the side of the base and/or cap portions. The rail portion 15 includes a stop arm 21 that pivots within a recess and engages opposite stop surfaces to define the range of rotation of the hinge. The hinge structure of the side portion is initially engaged with the hinge structure of the base or cap portions, for example when the side portion is in an open position, e.g. at 30° to vertical, and is then rotated to a closed position with the hinge structures mating such that the side portion is rotatably secured to the base or cap portion. The side portion can also include a mating structure that is snap-fit with a longitudinal edge of one or both of the base and cap portions 8, 10, or the end portions.

In one embodiment, an edge of the side portion opposite the hinge structure includes a rail 23 that is secured with a clamp/latch device, snap-fit or other securing device that engages the cap or base portions to releasably secure the side portion in the closed position. For example, in one embodiment, a clamp device includes a latch member 25 that engages a lip portion of the rail 23, and a tightening member 27 that threadably engages a captured nut 29 to secure the side panel to the cap portion 10. Seals or gasket members can be secured between the peripheral edges of the side panels and the base portion, cap portion and end portion to keep moisture out of the interior chamber of the light housing.

In this way, different side portions can be quickly and easily removed or installed to provide different instructional indicia, thereby making the overall light modular in construction. At the same time, the side portions can be removed to provide access to an interior chamber 36 of the sign, for example to replace one or more lamps or conduct other maintenance or repairs.

In one embodiment, and referring to FIGS. 5A-C, the side portions 12 permit the transmission of light therethrough, and may be translucent and/or transparent. It should be understood that the housing could have only a single side portion, or more than two side portions. In various embodiments, the side portions can include a fiberglass or polycarbonate material substrate, such as a fiber reinforced acrylic and/or a white or clear polycarbonate material, or combinations thereof. The side portions can also be made of other plastics or glass, or of metal with openings formed therein, or of combinations of the various materials. A silkscreen legend or template can be applied to the inner or outer face thereof to provide instructional indicia 42. In one embodiment, a masking is applied to define the indicia, with ink applied by way of silk screen process. The masking is then removed to provide the indicia, which contrast with the surrounding ink. The ink can be translucent, such that light passes through the entirety of the side portion, but provides a contrast between those portions that are inked and the indicia. In other embodiments, portions of the side portion are provided with a masking agent, such as a paint that do not permit the transmission of light therethrough.

Instructional indicia 42 can include without limitation designations, such as street or store names, directional indicia, such as south or north, alphanumeric characters, symbols, such as arrows or airplanes, or any other informational indicia, such as an “H” for hospital. The indicia can also be formed by applying an adhesive material to the side portions. In operation, light is permitted to pass through the indicia, while it is substantially blocked in the areas surrounding the indicia, or is more diffused so as to provide a contrast. The indicia 42 can also be formed by forming openings in the side portions. In one embodiment, both of the side portions 12 have instructional indicia 42 formed thereon, while in other embodiments, only one side portion provides instructional indicia, with the other side preventing the transmission of light therethrough. For example, in one embodiment, a side of the housing opposite the side portion is mounted to a fixed surface such as a wall. Indeed, in such an embodiment, the housing may be open on the side mounted to the wall.

Referring to FIG. 6, the sign 6 can be installed with a longitudinal axis 46 lying in a horizontal plane, for example by providing mounting brackets 44 secured to the base portion, such that the cap portion is spaced downwardly from the base portion. In other embodiments, the base is positioned at the bottom, with the cap portion spaced upwardly from the base portion. In other embodiments, the sign can be installed with the longitudinal axis 46 oriented vertically, with the base, cap and side portions extending in the vertical direction. Of course, the sign can be installed at other angles between horizontal and vertical orientations.

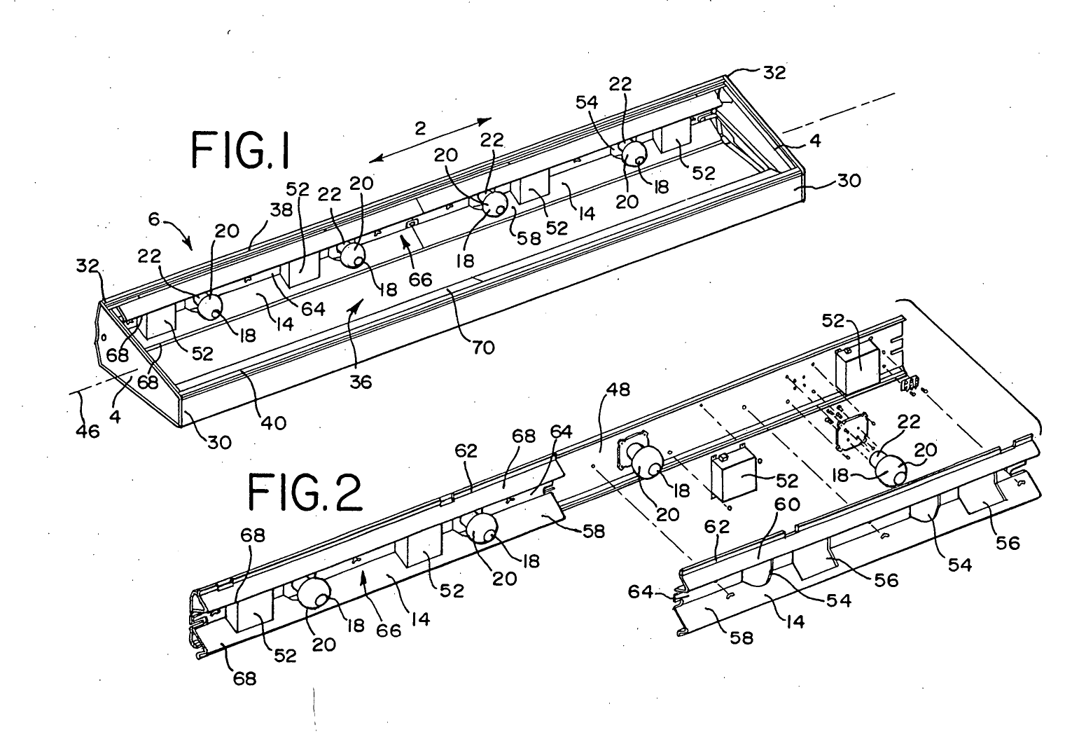

Referring to FIGS. 1 and 2, an elongated member 48 is secured to the base portion 8. The base portion may also include ballast and mounting components 50 suitable for carrying the weight of the sign. It should be understood that the elongated member 48 can be secured to the cap portion, or be disposed between the base and cap portions. In various embodiments, the elongated member is integrally formed with or defines one of the cap or base portions, or one of the side portions.

As shown in FIGS. 1-3, a plurality of induction lamps 18, shown as four, are connected to the elongated member 48. The term “plurality” means two or more. In other embodiments, conventional lamps, such as filament lamps or fluorescent lamps, can be used.

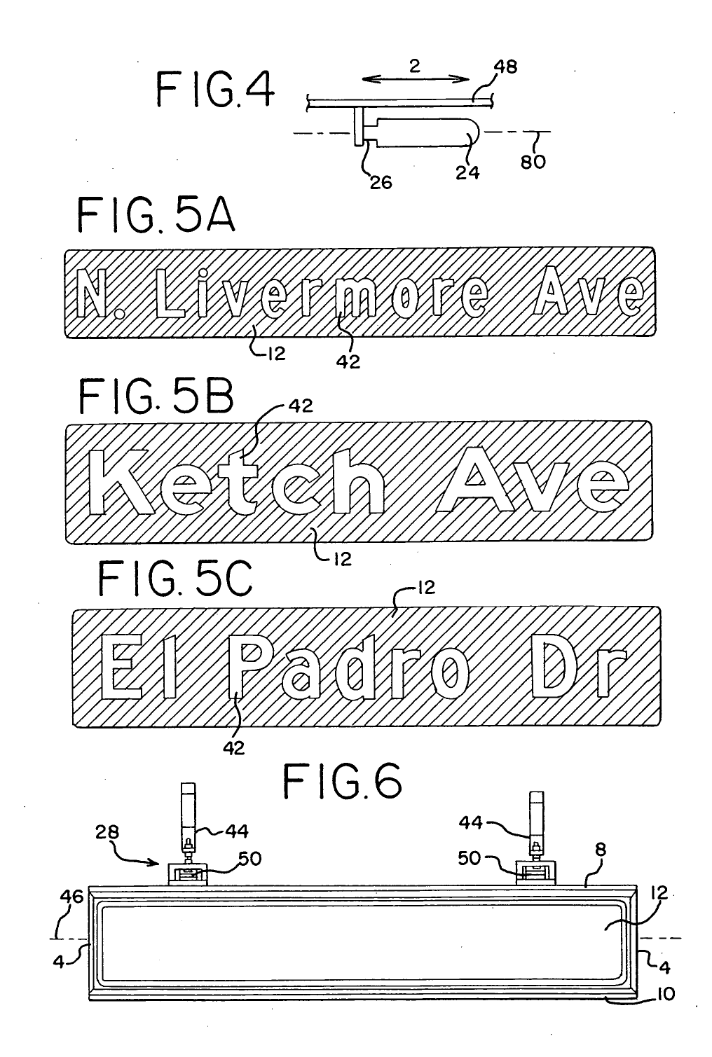

The lamps are spaced apart along the longitudinal direction 2. In one embodiment, the induction lamps 18 include a spherical lamp portion 20 and a plug portion 22 that is connected to the elongated member, or a socket portion disposed adjacent thereto. In another embodiment, the lamp portion 24 is cylindrical, as shown in FIG. 4. The lamp portion 24 has an axis 80 running parallel to the longitudinal axis 46. A bracket extends down from the elongated member and is connected to the plug portion 26. A high frequency generator 52 is also mounted to the elongated member next to each lamp.

The induction lamps 18 have an induction coil or energy-coupling antenna with electrodes, which uses the application of low-pressure gas discharge technology. The center of the lamp is the induction coil powered by the electronic unit at the base of the lamp. The glass assembly, or lamp portion 20, surrounding the induction coil contains an electron-ion plasma material and is filled with an inert gas. The inner portion of the glass is lined with a phosphor coating that is similar to that in fluorescent lamps. The antenna transmits the energy generated by the primary coil of an induction system to the gas filled chamber, where it creates ultraviolet radiation and is then converted into lighting sources by the fluorescent power on the glass surface. One suitable induction lamp is the Duralite Induction Lamp system available from Tungda Electrical and Lighting Ltd., Hong Kong. Induction lamps have ultra-long lifetimes, rated for example at 120,000 hours, with low lumen depreciation of less than 50% at 120,000 hours. In addition, the induction lamps have high system efficacy, with no flicking, stroboscopic effect or noise. Moreover, the induction lamps have short ignition times (e.g., less than 0.5 seconds) and hot re-strike times. The phosphor coating also provides white light that has excellent color rendition (Ra>80), with no color deviation.

Referring to FIGS. 1-3 and 7, a pair of first reflectors 14 is secured to the elongate member. In one embodiment, the reflector is made of aluminum, e.g., specular or polished aluminum, and in one embodiment an electrically brightened, anodized and PVD coated aluminum available from ALANOD Aluminium-Veredlung GmbH and Company, Ennepetal, Germany. Of course, various reflective materials or reflective coatings know to one of skill in the art can be used. Each reflector includes openings 54, 56 shaped to receive the induction lamps 18 and the generators 52. The first reflector 12 includes a pair of inner reflective surfaces 58 that face each other, and face towards and are angled downwardly and outwardly from the lamp 18. A pair of outer reflective surfaces 60 are angled outwardly and upwardly from the inner reflector surfaces, and include a horizontal lip portion 62 formed along a longitudinal edge thereof. The lip portion is secured in a groove formed in part by the base portion.

A center base portion 64 extending between the inner reflective surfaces 58 is secured to the elongated member 48 with a plurality of fasteners, including for example studs 33 which can be slid into a track formed along the center of the base portion, for example by extrusion, engaged by wing nuts 35. In one embodiment, the surfaces 58 and 60 form an angle of about 60° therebetween, with the surface 58 forming an angle of about about 120° with the horizontal portion 64. Of course, other angles would also work, for example the surfaces 58 can 60 can form an angle of between about 15 and 130 degrees, and in one embodiment between about 30 and about 90 degrees therebetween. The center base portion 64 and the inner reflective surfaces 58 form a channel 66 in which the induction lamps are disposed. The overall cross-sectional shape of the first reflector 14 is substantially an upside down W-shape, with the middle, or base portion, of the W-shape having a width. The inner and outer reflective surfaces 58, 60 define a pair of side walls 68 that cover at least a portion of the induction lamp sphere 20, e.g., 20-100%, and in one embodiment, between about 50 and 90%, in one embodiment between about 50 and 60% and in one embodiment about 80%, when viewing the lamp 18 from the side along a plane substantially parallel to the elongated member as the lamps are disposed in the channel 66. In this way, the side walls 68 extend between a portion of the lamp 18 and side portions 12 and thereby hide or limit the hot spots of the spherical induction lamps 18, while at the same time reflect the light downwardly and outwardly by way of the reflective surfaces. For example, the inner reflective surface 58 on one side of the induction lamp 18 reflects the light from the lamp 18 to the other side thereof such that it can pass out of the side portion 12 opposite the inner reflective surface 18. It should be understood that the first reflectors could be made as a single elongated unit, or as a plurality of components.

Referring to FIGS. 1, 3 and 8, a second reflector 16 is formed as a substantially upside-down V-shape. It should be understood that when the induction lamps are secured to a base portion that is positioned at the bottom of the lamp, rather than the top, the first and second reflectors would be upright W and V shaped members. Of course, the reflectors are side-ways W and V-shaped members if the base portion is positioned along one side of the light. The second reflector 16 includes a pair of outwardly facing reflective surfaces 70, each having a longitudinal edge that is secured to the cap portion. The reflective surfaces 70 face away from each other and reflect light from the induction lamp, or a reflective surface on the first reflector and direct it toward adjacent side portions 12 such that it can be transmitted therethrough. In one embodiment, the surfaces form an angle of about 45° therebetween, although other angles between about 15 and about 125 degrees, and in one embodiment between about 30 and about 60 degrees would also work. The surfaces 70 also face away from the cap portion and toward the base portion. The second reflector includes a pair of leg portions having a horizontal flange 51 and an angled leg portion 53 that are secured in a channel 55 formed in the cap portion.

In one embodiment, the first and second reflectors are integrally formed or are connected as a single unit, while allowing light to be transmitted out of the side portion. In other embodiments, one or both of the first and second reflectors are omitted, depending on the configuration of the sign and the positioning of the lamps, with the sign including a single reflector located at the top or bottom of the sign, or configured without any reflectors. In another embodiment, reflectors are positioned adjacent the end portions of the sign. In yet another embodiment, the inner surface of portions of the side panels can be configured as a reflective surface, or have a reflector secured thereto.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. An internally illuminated sign comprising:
an elongated housing defining an interior chamber and a longitudinal axis and comprising opposite end portions, at least one side portion and a elongated member disposed between said opposite end portions, and wherein said at least one side portion comprises instructional indicia and permits the transmission of light therethrough;
a plurality of induction lamps disposed in said interior chamber and connected to said elongated member, wherein said plurality of induction lamps are longitudinally spaced apart;
a first reflector disposed adjacent said plurality of induction lamps; and
a second reflector spaced from said first reflector.

2. The internally illuminated sign of claim 1 wherein said first reflector comprises a first reflective surface positioned on one side of said plurality of induction lamps opposite said at least one side portion comprising said indicia, wherein said first reflective surface faces said plurality of induction lamps and said at least one side portion.

3. The internally illuminated sign of claim 2 wherein said second reflector comprises a second reflective surface having at least a portion positioned on a side of said plurality of induction lamps opposite said one side of said plurality of induction lamps, wherein said second reflective surface faces said at least one side portion.

4. The internally illuminated sign of claim 1 wherein said at least one side portion comprises a pair of opposite side portions, both of which comprise instructional indicia and permit the transmission of light therethrough.

5. The internally illuminated sign of claim 4 wherein said first reflector comprises a pair of first reflective surfaces positioned on opposite sides of said plurality of induction lamps, wherein said pair of first reflective surfaces face each other.

6. The internally illuminated sign of claim 5 wherein said second reflector comprises a pair of second reflective surfaces facing away from each other.

7. The internally illuminated sign of claim 1 wherein at least some of said plurality of induction lamps each comprise a spherical lamp portion.

8. The internally illuminated sign of claim 1 wherein at least some of said plurality of induction lamps each comprise a cylindrical lamp portion defining a lamp axis, wherein said lamp axis is substantially parallel to said longitudinal axis.

9. The internally illuminated sign of claim 8 wherein said at least some of said plurality of induction lamps each further comprise a plug portion connected to said elongated member.

10. The internally illuminated sign of claim 1 wherein said housing further comprises a base portion and a cap portion oriented substantially parallel to said longitudinal axis.

11. The internally illuminated sign of claim 10 wherein said base portion comprises said elongated member.

12. The internally illuminated sign of claim 11 wherein said first reflector is connected to said base portion and said second reflector is positioned adjacent said cap portion.

13. The internally illuminated sign of claim 10 wherein said first reflector comprises a first reflector surface facing away from said base portion and toward said cap portion, and said second reflector comprises a second reflector surface facing away from said cap portion and toward said base portion.

14. The internally illuminated sign of claim 1 wherein said plurality of induction lamps each comprises a lamp portion, and wherein said first reflector extends along at least one side of at least some of said plurality of induction lamps between said lamp portions of said at least some of said plurality of induction lamps and said at least one side portion.

15. The internally illuminated sign of claim 1 wherein said second reflector has a substantially V-shaped cross-section.

16. The internally illuminated sign of claim 1 wherein said first reflector has a substantially W-shaped cross-section.

17. An internally illuminated sign comprising:
an elongated housing defining an interior chamber and a longitudinal axis and comprising a base portion, a cap portion, opposite end portions connected to opposite ends of said base and cap portions respectively and opposite side portions extending between said opposite end portions, wherein said opposite side portions each comprise instructional indicia and permit the transmission of light therethrough;
a plurality of induction lamps disposed in said interior chamber and connected to said base portion, wherein said plurality of induction lamps are spaced apart along said longitudinal axis;
a first reflector positioned adjacent said base portion; and
a second reflector spaced from said first reflector and positioned adjacent said cap portion.

18. The internally illuminated sign of claim 17 wherein said first reflector comprises a pair of first reflective surfaces facing inwardly toward each other and away from said base portion toward said cap portion, and wherein said second reflector comprises a pair of second reflective surfaces facing outwardly away from each other and away from said cap portion toward said base portion.

19. The internally illuminated sign of claim 17 wherein at least one of said plurality of said induction lamps comprises a spherical lamp portion.

20. The internally illuminated sign of claim 17 wherein at least one of said plurality of said induction lamps comprises a cylindrical lamp portion.
